(19) United States
(12) Patent Application Publication
(10) Pub. No.: US 2003/0033582 A1
(43) Pub. Date: Feb. 13, 2003

(54) Representations for estimating distance

(75) Inventors: Philip Nathan Klein, Berkeley, CA (US); Igor Ioppe, San Francisco, CA (US); Tasso Roumeliotis, Berkeley, CA (US)

Correspondence Address: Philip W. Woo, SKJERVEN MORRILL MacPHERSON LLP, Three Embarcadero Center, 28th Floor, San Francisco, CA, 94111, US

(73) Assignee: WaveMarket, Inc.

(21) Appl. No.: 10/039,539

(22) Filed: Jan. 4, 2002

Related U.S. Application Data
(60) Provisional application No. 60/289,586, filed on May 9, 2001.

(51) Int. Cl. G06F 17/50; G06F 9/44

(52) U.S. Cl. 716/4; 716/2; 716/12

(57) ABSTRACT

In one aspect, a method and system are provided for preprocessing a weighted planar undirected graph and representing the results of the preprocessing so as to facilitate subsequent approximate distance queries. A representation can be constructed so that an approximate distance from one node to another can be computed quickly. Also, the representation in one embodiment stores information for computing distances in a relatively compact format, thus reducing memory requirements. In another aspect, a method and system are provided which use the representation for rapid computation of distances.

### CROSS-REFERENCE TO RELATED APPLICATION

This application claims the benefits under 35 U.S.C. § 119(e) of U.S. Provisional Application Serial No. 60/289,586, filed May 9, 2001, the complete disclosure of which is incorporated herein by reference.

### BACKGROUND

1. Field of the Invention

The invention generally relates to the field of processed representations and distance estimation.

2. Background Information

Representation of systems is a familiar process for analysts in a wide range of fields. Representation of systems includes, for example, representing networks (whether the network corresponds to a road network; or a set of geographic features, like connected waterways; or layout features of a semiconductor device). Despite advances in processing power and memory technology, speed and efficiency of analysis of a network remains a consideration for many applications.

For many sectors in the modem world, an understanding of the distance between two points in a network is important. These sectors may include, for example, fleet enterprises having a number of vehicles (e.g., car rental companies, delivery companies, etc.), mobile professionals (e.g., consultants, lawyers, doctors), advertising and promotions for merchants (e.g., delivered over wireless devices), supply chain management (e.g., for coordinating between manufacturers, wholesalers, distributors, etc.), and factory planning. These sectors may be concerned about distances, for example, in the interests of improving efficiency, managing resources, optimizing routes, and tracking of fleet/inventory.

Various techniques have been previously developed for estimating distances. One such technique has been described by Mikkel Thorup (see, e.g., “Compact Oracles For Reachability and Approximate Distances In Planar Digraphs”, preprint bearing date of Apr. 27, 2001, publication date if any unknown)(incorporated herein by reference). With this technique, a computer is used to preprocess a planar directed graph (digraph) and represent the results of the preprocessing in the computer's memory so as to facilitate subsequent distance queries. Upon input of two nodes of a network, the computer can use the representation to find the approximate distance from one node to the other. In particular, suppose ε is a value between 0 and 1. Suppose the maximum finite distance in the graph is D. Suppose the number of nodes in the network is n. Computation of the estimate requires the computer to execute O(log log D+ε⁻¹) elementary operations. Upon input of two nodes, the computer computes an estimate of the distance that is at least the true distance and at most 1+ε times the true distance. The technique requires O(n·log n·log D·ε⁻¹) words of computer memory for the representation. As the number of nodes in a network grows, so does the requirement for computer memory to store the representations. For a large directed planar network, the amount of data for representing the pre-processing for the network can be unwieldy, and the storage space needed can be quite significant. Furthermore, it should be emphasized that Thorup's technique is specifically designed to handle the difficulties inherent in representing directed graphs. Accordingly, direct application of Thorup's technique to distance estimation with regard to undirected planar networks is not desirable.

### SUMMARY

The drawbacks and limitations of known network representation and distance estimation techniques have been substantially reduced or eliminated by the present invention.

In many applications, notably those involving approximate distances in street maps, it suffices to work with undirected graphs. Embodiments of the invention to be described in this application address this important case. In one embodiment, a representation is provided that is more compact than that of previously developed techniques. Such representation may requires O(n·log n·ε⁻¹) words of computer memory and reduces the time required to compute distance estimates to O(ε⁻¹) (and often less in practice, depending on the nodes queried).

In one embodiment of the new representation, the storage required is: O(n) words of O(log n) bits each, O(n log n) words storing distances in a suitable representation (e.g. floating-point numbers or integers), and O(ε⁻¹ nlog n) words each consisting of O(logε⁻¹) bits. For reasonable values of ε, several O(logε⁻¹)-bit words can fit in the space occupied by a floating-point number or an integer, so this technique provides a further reduction in storage requirements.

Embodiments of the invention facilitate the quick computation of approximate distance in planar embedded networks. These embodiments can be adapted to work on near-planar graphs as well, graphs that upon removal of a few exceptional arcs are planar. An embedded planar network (or embedded planar graph) is a network (or graph) drawn on the plane in such a way that any two links of the network (edges of the graph) do not cross. For example, a street map is nearly a planar graph; there are local exceptions to planarity, such as overpasses. Such local exceptions can be handled specially in conjunction with the method described in this application.

According to embodiments of the invention, a method and system are provided for preprocessing a weighted planar undirected graph and representing the results of the preprocessing so as to facilitate subsequent approximate distance queries. A representation can be constructed so that an approximate distance from one node to another can be computed quickly. Also, the representation in one embodiment stores information for computing distances in a relatively compact format, thus reducing memory requirements. According to other embodiments, a method and system are provided which use the representation for rapid computation of distances.

According to one aspect of one embodiment of the invention, a process for constructing a representation of a network includes the following: providing an input graph, wherein the input graph comprises nodes and edges; deriving at least one separator comprising one or more shortest paths comprising a plurality of nodes, wherein said nodes in said shortest paths comprise portal nodes; deriving a recursive decomposition tree of said input graph, wherein said recursive decomposition tree comprises a plurality of vertices, each vertex having a depth value and each vertex corresponding to one or more nodes; compiling a first table of data for nodes of said graph wherein said first table has a plurality of first entries each indexed by a node; deriving, for each node in said first table, a second table from said recursive decomposition tree wherein said second table has a plurality of second entries each indexed according to said depth value of said vertices; deriving, for each said depth value in said second table, a third table having a plurality of third entries indexed according to said shortest paths of said separator; and deriving, for each said indexed third entries, corresponding distance values.

In another aspect of another embodiment of the invention, a representation is provided which is derived from an input graph for a network, the input graph having nodes and edges. One or more separators comprise one or more shortest paths. Each shortest path may include a plurality of nodes, wherein the nodes in the shortest paths comprise portal nodes. A recursive decomposition tree of the input graph comprises a plurality of vertices, each vertex having a depth value and each vertex corresponding to one or more nodes. The representation may include a first table of data for nodes of the input graph. The first table has a plurality of first entries each indexed by node. For each first entry in the first table, a second table is provided having a plurality of second entries, each of which is indexed according to the depth values of corresponding vertices. For each such second entry in the second table, a third table is provided having a plurality of third entries, each of which is indexed according to the shortest paths of the at least one separator. For each third entry in the third table, corresponding distance values are provided. For any node w on a shortest path, there is a node z such that the distance from a corresponding vertex v to node z plus the distance from node z to node w is at most (1+(1−c/2)ε₀) times the distance from the vertex v to node w, wherein c is a factor ranging in value from zero to one and ε₀ is a factor ranging in value between zero and one.

In a further aspect of another embodiment of the invention, a system for estimating distances includes a computing platform comprising a processor and a memory. A processed representation of an undirected network is stored in the memory. The processed representation may include nodes and edges, and a recursive-decomposition tree of the network. The tree may include vertices, each of which has a depth value. The processed representation further includes tables comprising distance value data. The computer is adapted to identify a first node and a second node, each of which has a corresponding vertex in the tree. The first node and the second node have a least common ancestor vertex. The computer is configured to determine a minimum estimated distance between said first node and said second node, by deriving from said tables corresponding distance value data indexed according to the depth value of the least common ancestor vertex.

Those of ordinary skill will appreciate that different embodiments of the present invention can be implemented in hardware, software, microcode, or a combination of hardware, software, and microcode. In certain embodiments, software implementing aspects of the present invention can be stored on any machine or human readable medium, including but not limited to one or more hard drives, CD-ROMs, floppy disks, memory chips, flash memory, bubble memory, or other appropriate memory device. In other embodiments, hardware implementing aspects of the present invention may include but is not limited to a microprocessor, an ASIC, a programmable logic device, a reprogrammable logic device, a mask programmed device, and one or more interface devices (such as keyboards, mouses, tablets, handwriting recognition screens, microphones, output screens, monitors, flat panel displays, plasma displays, LCDs, raster displays, video screens, voice synthesizers, speakers, audio input/output systems, touchscreens, stylus screens, modems, network connections, and printers).

### BRIEF DESCRIPTION OF THE DRAWINGS

For a more complete understanding of the present invention and for further embodiments and aspects, reference is now made to the following descriptions taken in conjunction with the accompanying drawings, in which:

FIG. 1A illustrates an exemplary planar graph comprising a plurality of nodes and edges.

FIG. 1B illustrates a number of separators for the exemplary planar graph of FIG. 1A.

FIG. 2 illustrates an exemplary depiction of separators for a recursive decomposition of the planar graph of FIG. 1.

FIG. 3 illustrates an exemplary recursive-decomposition tree for the planar graph of FIG. 1 and corresponding subgraphs of the exemplary depiction of FIG. 2.

FIG. 4 illustrates an exemplary table that may be part of a representation for the planar graph of FIG. 1 in accordance with one aspect of one embodiment of the invention.

FIG. 5 illustrates an exemplary table that may be part of a representation for the planar graph of FIG. 1 in accordance with one aspect of one embodiment of the invention.

FIG. 6 illustrates an exemplary separator having two paths.

FIG. 7 illustrates exemplary distances between an arbitrarily selected node and a plurality of nodes along one of path of the separator of FIG. 6.

FIG. 8 illustrates exemplary distances between a root node and a plurality of nodes along one path of the separator of FIG. 6.

FIG. 9 illustrates a structure that may be part of a representation for a planar graph in accordance with one aspect of one embodiment of the invention.

FIG. 10 is a flowchart illustrating a method for representing a planar graph in accordance with one aspect of one embodiment of the invention.

FIG. 11 is a flowchart illustrating a method for performing phase 1 processing in accordance with one aspect of one embodiment of the invention.

FIG. 12 is a flowchart illustrating a method for performing phase 2 processing in accordance with one aspect of one embodiment of the invention.

FIG. 13 illustrates two exemplary nodes on opposite sides of an exemplary separator for which it may be desirable to estimate a distance.

FIG. 14 is a flowchart illustrating a method for estimating distance in accordance with one aspect of one embodiment of the invention.

FIGS. 15A and 15B are block diagrams illustrating exemplary hardware and software environments in which a system for performing the methods and techniques described herein may operate, in accordance with one or more embodiments.

In the drawings, like features are typically labeled with the same reference numbers across the various drawings.

### DETAILED DESCRIPTION

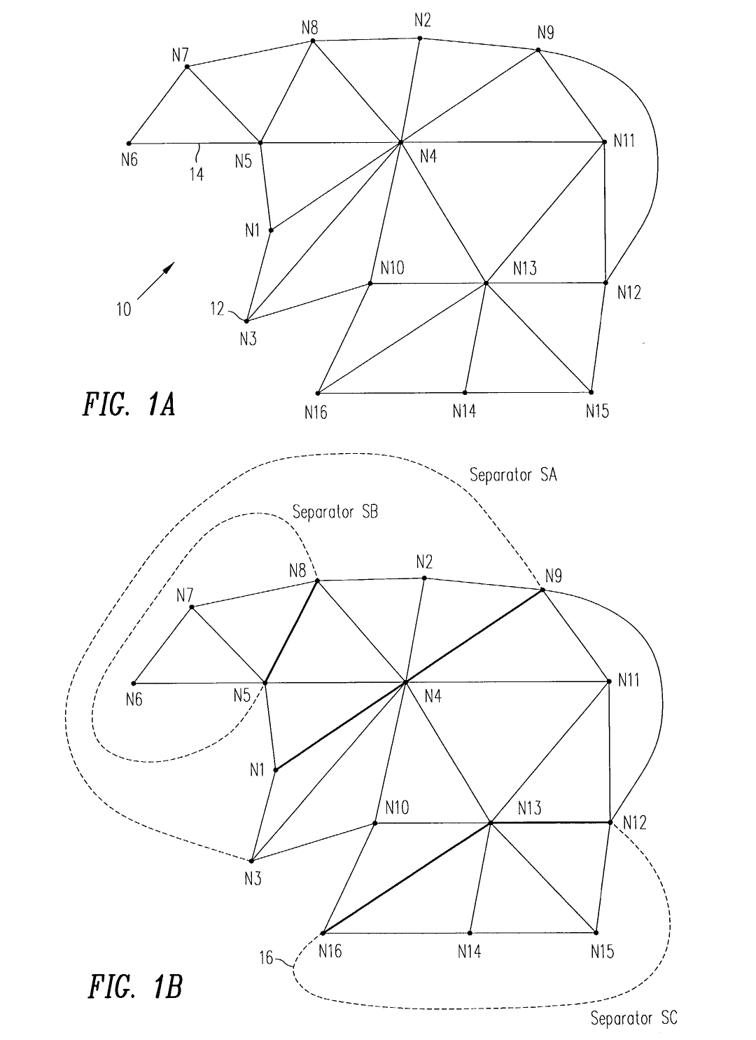

The preferred embodiments of the present invention and their advantages are best understood by referring to FIGS. 1A through 15B of the drawings. Like numerals are used for like and corresponding parts of the various drawings.

Turning first to the nomenclature of the specification, the detailed description which follows is represented largely in terms of processes and symbolic representations of operations performed by conventional computer components, such as a local or remote central processing unit (CPU) or processor associated with a general purpose computer system, memory storage devices for the processor, and connected local or remote pixel-oriented display devices or audio input/output devices. These operations include the manipulation of data bits by the processor and the maintenance of these bits within data structures resident in one or more of the memory storage devices. Such data structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art. Those of ordinary skill will understand that the modifications or convention used with different specific hardware or software are within the scope of the present invention, and that many different embodiments of the present invention may be implemented using different specific hardware and software.

For purposes of this discussion, a process, method, routine, or sub-routine is generally considered to be a sequence of computer-executed steps leading to a desired result. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for computer operations, and that these terms are merely conventional labels applied to physical quantities that exist within and during operation of the computer.

It should also be understood that manipulations within the computer are often referred to in terms such as adding, comparing, moving, searching, or the like, which are often associated with manual operations performed by a human operator. It must be understood that no involvement of the human operator may be necessary, or even desirable, in the present invention. The operations described herein are machine operations performed in conjunction with the human operator or user that interacts with the computer or computers.

In addition, it should be understood that the programs, processes, methods, and the like, described herein are but an exemplary implementation of the present invention and are not related, or limited, to any particular computer, apparatus, or computer language. One exemplary computer language for implementing embodiments may include C programming language. Rather, various types of general purpose computing machines or devices may be used with programs constructed in accordance with the teachings described herein. Similarly, it may prove advantageous to construct a specialized apparatus to perform the method steps described herein by way of dedicated computer systems with hard-wired logic or programs stored in non-volatile memory, such as read-only memory (ROM).

Planar Graph

Referring now to the drawings, FIG. 1A illustrates an exemplary planar graph 10 comprising a plurality of nodes 12 (separately labeled N1, N2, N3, . . . , N16, but only one of which is provided with a reference numeral) and edges 14 (separately labeled E1, E2, E3, . . . , E_, but only one of which is provided with a reference numeral). In one embodiment, each node 12 may correspond to a physical location, such as, for example, a position on a factory floor, a building (e.g., warehouse) that is associated with a supply chain, an intersection of two streets, a city, or any other location. Each edge 14 may logically or physically connect two nodes and may have associated with it a corresponding cost between the two connected nodes 12. Such cost can be, for example, a distance between two physical locations or the time associated with traveling between the two locations.

According to various embodiments, the present invention provides methods and systems which allow distances between the nodes 12 in graph 10 to be efficiently and rapidly estimated using a relatively smaller amount of storage (e.g., computer memory) for information to support such estimation. Such distance estimation is useful for various applications and services. Following are examples of ways in which distance estimation is applied to problems arising in software for location-based services.

One service that is useful to mobile users is a service that, given a starting location and a partial description of desired points of interest (e.g. merchant category), finds those points of interest satisfying the description that are closest to the given starting location. It may be desirable in some cases that “closest” is considered or measured as the distance or travel time along roads (rather than simply straight-line distance, i.e., distance as the crow flies). In addition, it may be desirable in these cases that the results of this search be presented to the user in increasing order of distance, where, again, distance is measured as distance along roads or travel time along roads. One of ordinary skill in the art would understand that a faster method for distance estimation can be used in conjunction with other techniques to quickly obtain the desired answer in the desired form. Those of ordinary skill in the art will understand that distance data can take many forms, including expressing distances as travel time, and the invention is not so limited by the precise form of the distance data used for any particular application.

Another service arising in location-based services is that of finding a route from a given origin to a given destination. One of ordinary skill in the art would understand that a subroutine for distance estimation can be used to quickly find such a route.

Another such service is the provision of location-based alerts or similar technology. For a given user, a given geographical region or location, and perhaps some additional conditions, a computer system can be instructed to perform some specific action (e.g., send a message to the user's mobile phone) when the user enters the region or comes close to the location (and when the additional conditions hold, e.g., when the day is a weekday). This is called an alert. The software used to support this service may need to schedule requests for user's locations on an ongoing basis. A useful input to such a scheduler is the travel-time between the user's current location and the regions or locations relevant to that user's alerts. A fast method for distance estimation can therefore be useful as a subroutine for a scheduler.

In one aspect, embodiments of the invention comprise one or more methods (implemented, for example, on computer systems) for representing undirected planar graphs to support the computation of distance estimates. These methods may involve preprocessing a weighted planar undirected graph and representing the results of the preprocessing so as to facilitate subsequent approximate distance queries. Such representation of the planar graph may require a relatively smaller amount of storage space (e.g., computer memory). In another aspect, embodiments of the invention comprise one or more methods (also implemented, for example, on computer systems) for rapidly and efficiently computing estimates for distances between various nodes of the planar graph using the representations for the graph.

Planar Graph Separators and Recursive Graph Decompositions

Planar graph separators and recursive graph decompositions are well known to those of skill in the art. Nonetheless, a brief overview of separators and recursive graph decompositions is provided for convenience. Referring to FIG. 1B, the nodes 12 in planar graph 10 can be separated by one or more separators 16 (separately labeled SA, SB, and SC, but only one of which is provided with a reference numeral).

In general, for a planar embedded graph G (e.g., graph 10) with weights assigned to the nodes of the graph G, an α-balanced separator is a closed curve in the plane on which graph G is embedded with the following property: the nodes that are outside the curve have total weight at most ε times the sum of all weights in the graph, and similarly for the nodes inside the curve. A planar separator can also take into account weights assigned to edges and faces, although in a simplified scheme described herein according to one embodiment, that capability is not utilized. Any nodes that the curve intersects are considered part of the separator; their weights do not count in the sum. The weights assigned to nodes can be equal or, in some embodiments, can differ based on criteria such as geography, cost, or any of a plurality of other criteria. In this context, α can be 1/2, 2/3, or any other suitable factor (depending on the exact technique used).

Referring again to FIG. 1B, the separators 16 can be determined or “found” using various techniques understood by those of ordinary skill in the art. One exemplary separator-finding method derives from a lemma due to Lipton, R. and Tarjan, R. E., “A separator theorem for planar graphs,” SIAM Journal of Applied Mathematics, volume 36, pp. 177-189, 1979 (the entirety of which is incorporated herein by reference). With this lemma:

Let T be a spanning tree of a planar embedded triangulated graph G with weights on nodes. Then there is an edge e not belonging to T such that the strict interior and strict exterior of the simple cycle in T ∪ {e} each contains weight no more than ⅔ of the total weight.

The method associated with this lemma can be applied to a planar embedded graph G that is not triangulated. In particular, consider in turn each edge e not belonging to T, and calculate the weight of the interior and the exterior; select the edge e that minimizes the larger of the two weights computed for that edge (alternatively, stop upon considering an edge e for which both the weight of the interior and the weight of the exterior are sufficiently small). Then output the simple cycle in T ∪ {e}, where e is the selected edge. This procedure finds a ⅔-balanced separator in a planar embedded triangulated graph. The procedure can be adapted to handle graphs that are not triangulated as follows: first add artificial edges to the graph to triangulate the graph, then apply the above procedure. The edge selected may be an artificial edge, but it will still determine a separator. Thus, artificial edges may be added to the graph while preserving the planar embedding until each face is a triangle.

By the lemma, there is a (possibly artificial) edge e such that the simple cycle in T ∪ {e} is a separator. Let C be the simple closed curve in the plane corresponding to this simple cycle. Note that no edges of G cross this cycle, and that the nodes and tree edges of this cycle comprise a path from one endpoint of e through the tree to the other endpoint.

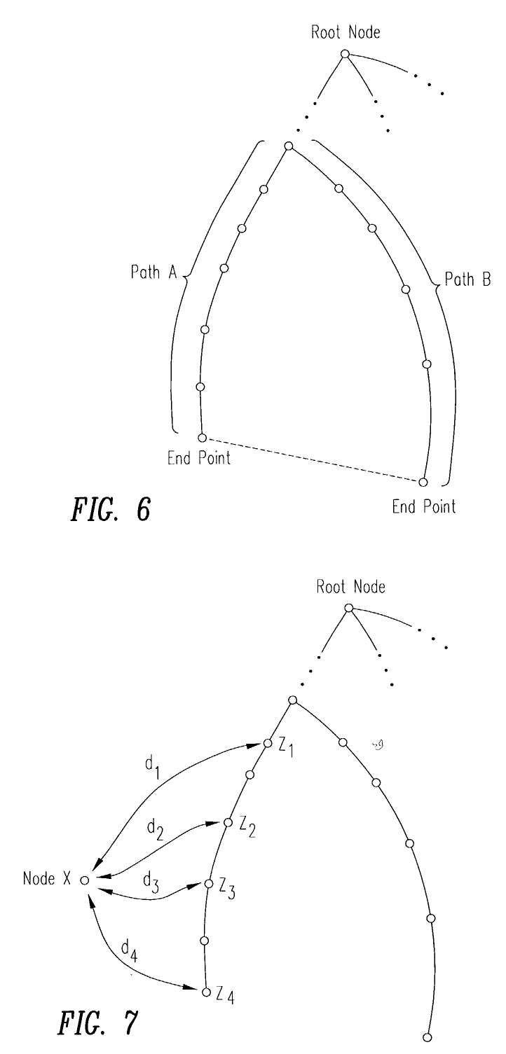

The separator-finding method described above may be applied to a spanning tree T that is a shortest-path tree of some graph, rooted at some node r of that graph. In this case, the separator can be decomposed into two paths, each starting from the least common ancestor of the endpoints of e, descending the shortest-path tree, and ending at one of the two endpoints. For example, FIG. 6 illustrates two paths that may be part of a separator 16. As depicted, these paths are labeled path A and path B. The value of α (the balance of the separator) is ⅔ for this method. Another method, which can be derived from a proof of the above-described lemma, yields three paths down the shortest-path tree instead of two paths, and it has a value of ½ for α instead of ⅔. The methods and systems, according to various embodiments of the present invention, can use the three-path method, the two-path method, or any other suitable method (with more or less paths).

Once a method is chosen for finding separators for a planar graph, a method for finding a recursive decomposition of the whole planar graph can be described.

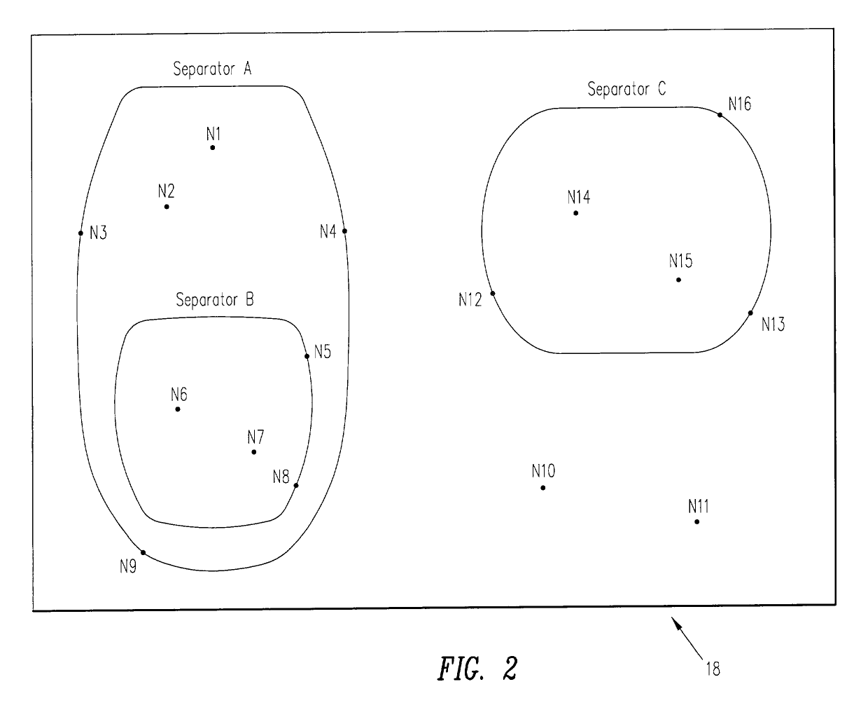

FIG. 2 illustrates an exemplary depiction 18 of separators 16 for a recursive decomposition of the planar graph 10 of FIG. 1. In depiction 18, separators 16 SA, SB, and SC divide a graph into various parts. In this example, separator 16 SA divides the whole planar graph into two parts—an interior (i.e., within the separator 16) and an exterior (i.e., outside the separator 16). Separator 16 SB divides the interior of separator 16 SA into two parts. Likewise, separator 16 SC divides the exterior of separator 16 SA into two parts. For each separator 16, any given node 12 of a graph 10 may lie (1) in the interior of the separator 16, (2) in the exterior of the separator 16, or (3) on the separator 16. In this example, separator SA may be associated with a root vertex of a recursive-decomposition tree for the graph, separator SB may be associated with one child vertex (e.g., right) of the root vertex, and separator SC may be associated with another child vertex (e.g., left) of the root vertex.

The notion of a recursive graph decomposition has several instantiations. Here is a description of one. The recursive graph decomposition of a graph 10 G can be a rooted tree (also called a recursive-decomposition tree) having a plurality of vertices v. Each vertex v of the recursive-decomposition tree is labeled with the following:

a set N(v) of nodes in G, and, if the vertex v is not a leaf of the tree,

an α-balanced separator S(v) of graph G, balanced with respect to the weight assignment in which each node in N(v) is assigned weight 1 and other nodes are assigned weight 0.

In one embodiment, a non-leaf vertex v of the tree has two children v₁ and v₂. The set N(v₁) labeling the first child v₁ is the set of nodes such that:

{x:x ε N(v) and x is outside the separator}

and the set H(v₂) labeling the second child v₂ is the set of nodes such that:

{x:x ε N(v) and x is inside the separator}.

Those skilled in the art will understand from the above that there is a method for computing a recursive decomposition for a planar embedded graph, given a subroutine for finding an α-balanced separator (for some α). There is some flexibility in deciding whether a vertex is to be a leaf of the recursive-decomposition tree. In one embodiment, it suffices to declare a vertex v to be leaf if N(v) contains a small number of nodes (e.g., fewer than fifty).

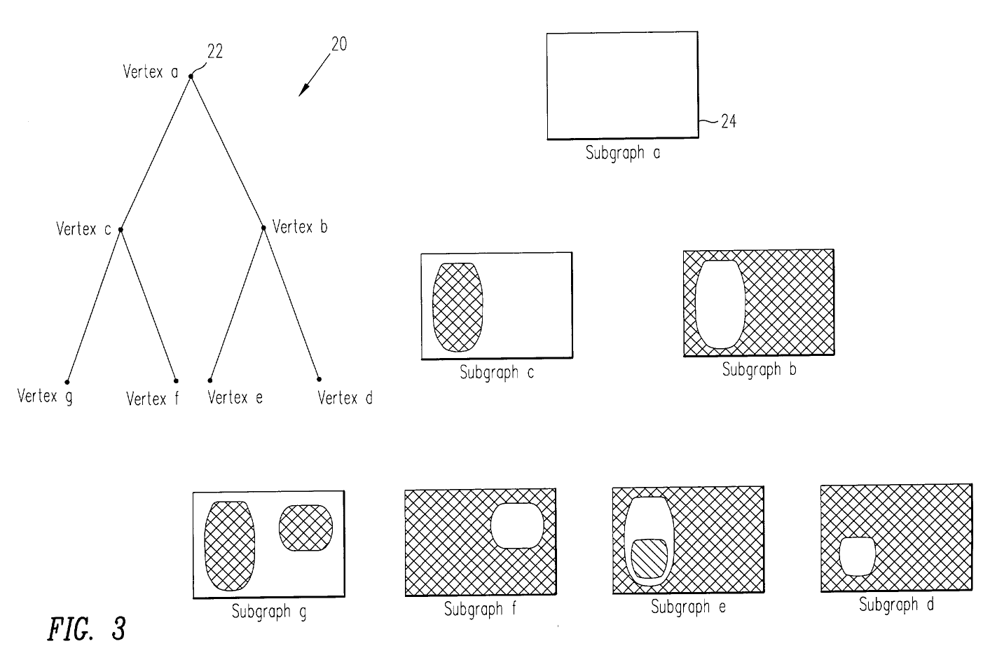

FIG. 3 illustrates an exemplary recursive-decomposition tree 20 for the planar graph 10 of FIG. 1 and corresponding subgraphs 24 of the exemplary depiction of FIG. 2. Recursive-decomposition tree 20 includes a plurality of vertices 22 (separately labeled vertex a, vertex b, vertex c, . . . , vertex g, but only one of which is provided with a reference numeral). For each vertex 22, corresponding subgraphs 24 (separately labeled subgraph a, subgraph b, subgraph c, . . . , subgraph g, but only one of which is provided with a reference numeral) of the graph are shown in non-crosshatch. Each subgraph can be a portion (up to all) of the graph, and may contain one or more nodes.

In recursive-decomposition tree 20,vertex a is the root vertex corresponding to subgraph a covering the whole graph. Vertices b and c are “children” of vertex a. Vertex b may be considered the “right” child of the root vertex and corresponds to subgraph b which comprises the interior of separator 16 SA. Vertex c may be considered the “left” child of root vertex a and corresponds to subgraph c which comprises the exterior of separator SA. Similarly, vertices d and e are children of vertex b, and vertices f and g are children of vertex c. Vertex d may be considered the right child of vertex b and corresponds to subgraph d which is interior to separator b and interior to separator a. Vertex e may be considered the left child of vertex b and corresponds to subgraph e which is exterior to separator b and interior to separator a. Vertex f may be considered the right child of vertex c and corresponds to subgraph f which is interior to separator c and exterior to separator a. Vertex g may be considered the left child of vertex c and corresponds to subgraph g which is exterior to separator c and exterior to separator a. Since each subgraph 24 contains one or more nodes, then the corresponding vertex 22 may be associated with such nodes.

Each vertex 22 may be considered to be either a “leaf” or “non-leaf” vertex. Leaf vertices do not have any children, whereas non-leaf vertices do have children. In decomposition tree 20 shown in FIG. 3, vertices d, e, f, and g are leaf vertices, and vertices a, b, and c are non-leaf vertices. In various embodiments, a leaf vertex can be associated with a single node or a cluster of nodes. For practical implementation, each subgraph 24 may contain a small number of nodes, and a corresponding leaf vertex may be associated with a table of distances between all pairs of nodes within the subgraph. Thus, computing distances between two nodes in the same leaf subgraph can, in one embodiment, be accomplished by a single look-up in a table.

Representing Planar Graphs

As described herein, in one aspect of the invention, methods and systems are provided for representing planar graphs to allow for rapidly and efficiently computing distance estimates. According to one embodiment, data and information for these representations can be stored in computer memory.

To derive or construct a representation for the planar graph, there is an arbitrarily chosen root node r, and a shortest-path tree T rooted at r. The representation has a table giving, for each node x in the graph, the distance d of node x from root node r. According to one embodiment, the recursive decomposition found may comprise separators found using the method associated with the lemma described above; a spanning tree used by the method must be the shortest-path tree T. In an alternative embodiment, another separator method can be used. In this alternative method, the nodes of the separator lie in a small number of paths, where each path's edges belong to the shortest-path tree and the path's nodes appear in nondecreasing order of distance from the root.

With a recursive-decomposition tree 20 of the whole input graph 10 G, each vertex 22 v of the recursive-decomposition tree 20 is labeled with a subset N(v) of the nodes of graph 10 G. If v is not a leaf of the recursive-decomposition tree 20, it is also labeled with an α-balanced path separator 16 S(v) of the graph. The separator 16 is chosen based on a weight assignment that assigns weight 1 to each node in N(v) and weight 0 to other nodes. The strict interior of the separator 16 contains at most an a fraction of the nodes of N(v) and similarly for the strict exterior of the separator 16. In some embodiments, each separator 16 consists of two or three paths down the shortest path tree, as previously described. See, for example, FIG. 6 which shows a separator 16 having a path A and a path B. But it should be understood that in other embodiments, each separator may have more or less paths down the shortest path tree.

The representation may include the following: (1) a table or structure specifying for each node x of the graph 10 the lowest vertex 22 v (leaf or non-leaf) such that N(v) contains x, (2) a table or structure specifying the depth of each vertex 22 v in the recursive-decomposition tree 20, and (3) a table or structure for the recursive-decomposition tree 20 allowing for quick computation of least common ancestors. Collectively, in one embodiment, these parts of the representation occupy O(n) words each of O(logn) bits. Thus, in one embodiment, for each node x in the graph 10, a table may give the leaf vertex v such that N(v) contains node x, and a representation of the tree 20 that permits quick computation of least common ancestors. This is understood by those of ordinary skill in the art. (see, e.g., Dov Harel and Robert Endre Tarjan, “Fast algorithms for finding nearest common ancestors”, SIAM Journal on Computing, 13(2):338-355, May 1984) (incorporated herein by reference).

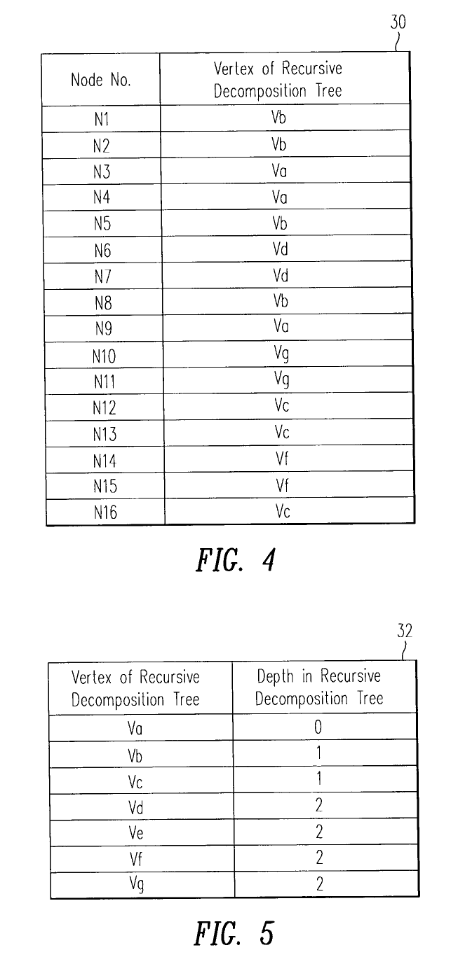

Referring again to FIG. 3, a structure or table may be built or organized for specifying, for each node of a graph 10, the lowest vertex 22 v (leaf or non-leaf) of the recursive-decomposition decomposition tree 20 such that the node belongs in the subgraph 24 (signified by N(v)) corresponding to that vertex 22 v. Here “lowest” means farthest from the root vertex (e.g., vertex a) in the recursive-decomposition tree. FIG. 4 illustrates an exemplary table 30 of this kind for the recursive-decomposition tree 20 of FIG. 3. Table 30 specifies a lowest vertex 22 of the recursive-decomposition tree 20 of FIG. 3 for each node of the planar graph 10 of FIG. 1. Such table 30 can be part of the representation for the associated planar graph 10, according to embodiments of the present invention.

Each vertex 22 may exist at a particular level or “depth” in the recursive-decomposition tree 20. In one embodiment, the depths are determined relative to the root vertex (e.g., vertex a in FIG. 3) such that, for example, a depth 0 corresponds to the root vertex, a depth 1 corresponds to the children of the root vertex, a depth 2 corresponds to the grandchildren of the root vertex, and so on. A structure or table may be built or organized for specifying the depth of each vertex 22 in the recursive-decomposition tree 20. FIG. 5 illustrates an exemplary table 32 of this kind for the recursive-decomposition tree 20 of FIG. 3. Table 32 specifies the depth of each vertex 22 in the recursive-decomposition tree 20 of FIG. 3. Such table 32 can be part of the representation for the associated planar graph 10, according to embodiments of the present invention.

The representation may include, for each node x in the graph 10, a table Tₓ. In one embodiment, the representation table Tₓ can be implemented, at least in part, as one or more arrays. This may include an array indexed according to nodes, where entries of the array can be made up of further arrays. There is an entry in table Tₓ for each vertex v of the recursive-decomposition tree 20 for which N(v) contains the node x. Note that the depth of the vertex 22 in the recursive-decomposition tree 20 can be used as the index for this table. The entry of table Tₓ corresponding to particular vertex v is a subtable with an entry for each of the paths 61 or 62 comprising the separator 16 S(v). For each path P, Tₓ [v][P] comprises the following information:

Distance-to-path: The distance d from node x to the closest node z in the path P. For example, FIG. 7 illustrates a node x, a sequence of four nodes z1, z2, z3, and z4 on path A of the separator 16 of FIG. 6 and respective distances d1, d2, d3, and d4 from node x to nodes z1, z2, z3, and z4.

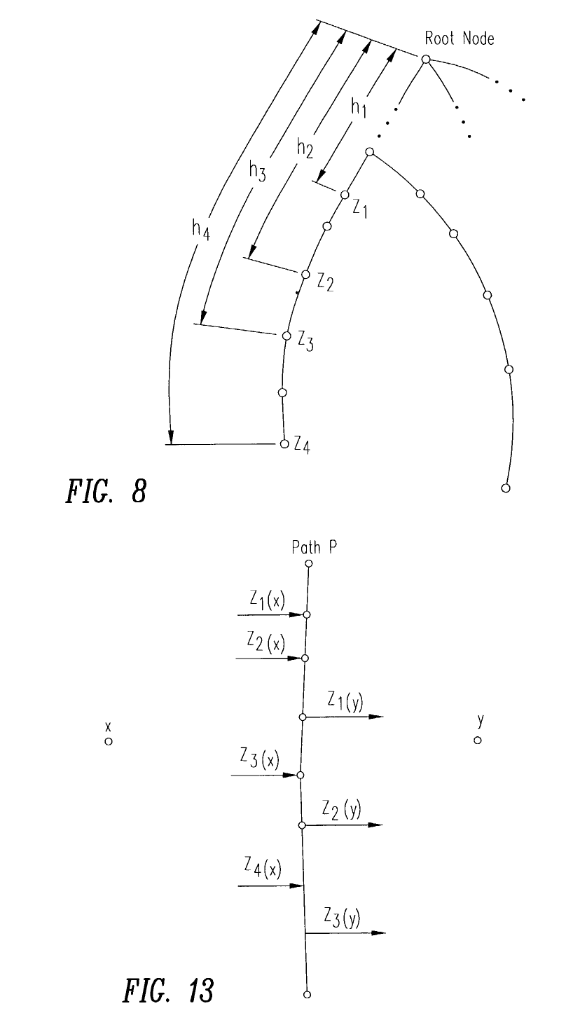

Distance-in-tree: The distance h from z to the root node r. FIG. 8 illustrates distances from the root node r to each of nodes z1, z2, z3, and z4 shown in FIG. 7.

Distance-sequence: A sequence of pairs (d₁, h₁), . . . , (dₖ, hₖ) where each dᵢ is the distance from node x to a node zᵢ on the path P, and hᵢ is the distance from zᵢ to the root node r. In some embodiments, the sequence of pairs can be a sequence of O(ε⁻¹) pairs. The choice of nodes zᵢ and the representation of dᵢ and hᵢ will be described below.

The number of entries in each table Tₓ is at most log_{1/α}n, which is O(logn). Again, the value of a can be either ⅔ or ½, depending on whether two-path or three-path separators are used. Each entry of a table Tₓ can be is a subtable with two or three entries, depending on whether 2-path or 3-path separators are used. Each of these entries of a subtable has, in one embodiment, O(ε⁻¹) distances. Thus the total number of distances in one embodiment of the representation is O(ε⁻¹n logn).

The distances can be represented directly, e.g., as floating-point numbers or integers, or using a compact representation, as described below. If the former, the number of entries in each table Tₓ is at most 2 (ε⁻¹+1). In this case, if 3-path separators are used, the total number of distances in the representation is at most log₂n·3·2(ε⁻¹+1).

The construction uses a parameter c that governs the precision of numeric representation. If all numbers are represented in high precision (e.g. floating-point), we take c=0. Otherwise, c is a constant less than one; e.g., c=1/16. Those of ordinary skill will appreciate that any appropriate value of c can be used depending on implementation details, commercial considerations, hardware limitations, software limitations, data limitations, or other factors, and that the precise value of c chosen does not limit the scope of the present invention.

Those of ordinary skill in the art will understand that any of numerous data formats, memory arrangements, and mathematical notations can be used within the scope of the invention. Those of ordinary skill understand that there are known approaches to data, network, graph, and software engineering that can provide the necessary properties within the scope of the present invention. Those of ordinary skill will understand that the representation is not limited to the logical representation described herein and that many other types of representations are within the scope of the present invention.

In one embodiment, the numbers of the information in Tₓ [v][P] (e.g., for distances dᵢ and hᵢ) can be represented more compactly than by full-precision floating-point numbers or integers. The goal is to represent the numbers imprecisely but with sufficient precision to preserve the quality of the approximation of distances, such that, for example, the distances be approximated to within a factor of 1+ε, where ε is a factor between zero and one.

In some aspects of the invention, several parameters derived from ε are used. For convenient reference, these ε parameters are listed below:

| Parameter/Variable | | | Exemplary Values in |
|---|---|---|---|
| Factor | Definition/Derivation | | range 0-1 (±) |
| ε | Set by implementer or by | | 1/16 |
| | data provider or by default | | |
| ε₀ | ε₀ = | 2ε | 1/8 |
| \overline{ε} | \overline{ε} = | (1 − c) ε₀ | 15/128 |
| \hat{ε} | \hat{ε} = | cε₀/2 | 1/256 |

There is a parameter c governing the representation of numbers. It may be required that c<1. One can, for example, set c=1/10. Let \hat{ε}=cε/2. The numbers may be represented to within an error of \hat{ε}d, where d is the number given above of the information in Tₓ [v][P]. Using these approximations in place of the true values of dᵢ and hᵢ could result in underestimating a distance l by \hat{ε}l. But compensation can be made for this when obtaining an estimate, as described below.

Assuming that sequence of pairs (dₗ, hₗ), . . . , (dₖ, hₖ) need to be represented, to represent hᵢ, use

ĥᵢ=┌(hᵢ−h)/(\hat{ε}d)┐

The choice of pairs (as described below) ensures that ĥᵢ can be represented with O(logε⁻¹) bits. An approximation to the value of hᵢ can be obtained from ĥᵢ. Namely, the approximation to the value of hᵢ is ĥᵢ\hat{ε}d+h. This approximation is always at least hᵢ, and exceeds hᵢ by less than \hat{ε}d.

To represent dᵢ, use

\tilde{d}ᵢ=┌(dᵢ−|h′ₗ−h|)/\hat{ε}d┐

where h′ᵢ=ĥᵢ\hat{ε}d+h is the approximation to hᵢ. The choice of pairs (as described below) ensures that dᵢ−|hᵢ−h| is between −d and d. Hence, |dᵢ−|h′ᵢ−h|| is at most d+\hat{ε}d. Hence, |\tilde{d}ᵢ|≦\hat{ε}⁻¹+1, and can therefore be represented with at most 1+log₂(\hat{ε}⁻¹+1) bits, which is O(log ε⁻¹). An approximation to the value of dᵢ can be obtained from \tilde{d}ᵢ and hᵢ. Namely, the approximation is \tilde{d}ᵢ\hat{ε}d+|h′ᵢ−h|. This approximation is always at least dᵢ, and is at most dᵢ+\hat{ε}d.

The nodes z₁, . . ., zₖ, from which the distances dᵢ and hᵢ are obtained (as described herein), may be chosen as follows. For any node z′ on the path P, let d(z′) denote the distance of z′ from node x, and let h(z′) denote the distance of z′ from the root node r. Start by letting z₀ be the node of the separator path P that is closest to the node x. Let \overline{ε}=(1−c)ε where c is the parameter governing representation of distances dᵢ and hᵢ. If the method for more compactly representing numbers for information in Tₓ [v][P] is not used and distances dᵢ and hᵢ are represented precisely, we take c=0 so \overline{ε}=ε. The remaining portal nodes zᵢ can then be chosen and ordered in three phases: Phase 1, Phase 2, and Phase 3.

In Phase 1, a set of nodes zᵢ is chosen that are closer than node z₀ to the root node r.

Let \overline{z}₀ denote the node zo discussed above with respect to distance-to-path. In other words, the node \overline{z}₀ is the node on the separator path P closest to node x.

Initialize i:=1

While there is a node \overline{z} in P that satisfies

\overline{z} is closer to the root than \overline{z}ᵢ₋₁ (condition (1))

d(\overline{z})<(1+\overline{ε})⁻¹(d(\overline{z}ᵢ₋₁)+h(\overline{z}ᵢ₋₁)−h(\overline{z})) (condition (2))

let \overline{z}₁ be the node z that is farthest from the root among all nodes in P satisfying condition (1) and condition (2).

Increment i:=i+1.

Let \overline{z}₁, . . . , \overline{z}ᵣ be the nodes chosen in Phase 1.

A exemplary flowchart of a method for performing Phase 1 processing is illustrated and described below with reference to FIG. 11.

In Phase 2, a set of nodes zᵢ is chosen that are farther than node z₀ from the root node r. A process similar to that for Phase 1 is used.

Let \hat{z}₀ denote the node z₀ discussed above with respect to distance-to-path. The node \hat{z}₀ is the node on the separator path P closest to node x.

Initialize i:=1

While there is a node \hat{z} in P that satisfies

\hat{z} is farther from the root than \hat{z}ᵢ₋₁ (condition (3))

d(\hat{z})<(1+\overline{ε})⁻¹(d(\hat{z}ᵢ₋₁)+h(\hat{z})−h(\hat{z}ᵢ₋₁)) (condition (4))

let \hat{z}ᵢ be the node \hat{z} that is closest to the root among all nodes in P satisfying condition (3) and condition (4).

Increment i:=i+1

Let \hat{z}₁, . . . , \hat{z}ₛ be the nodes chosen in Phase 2.

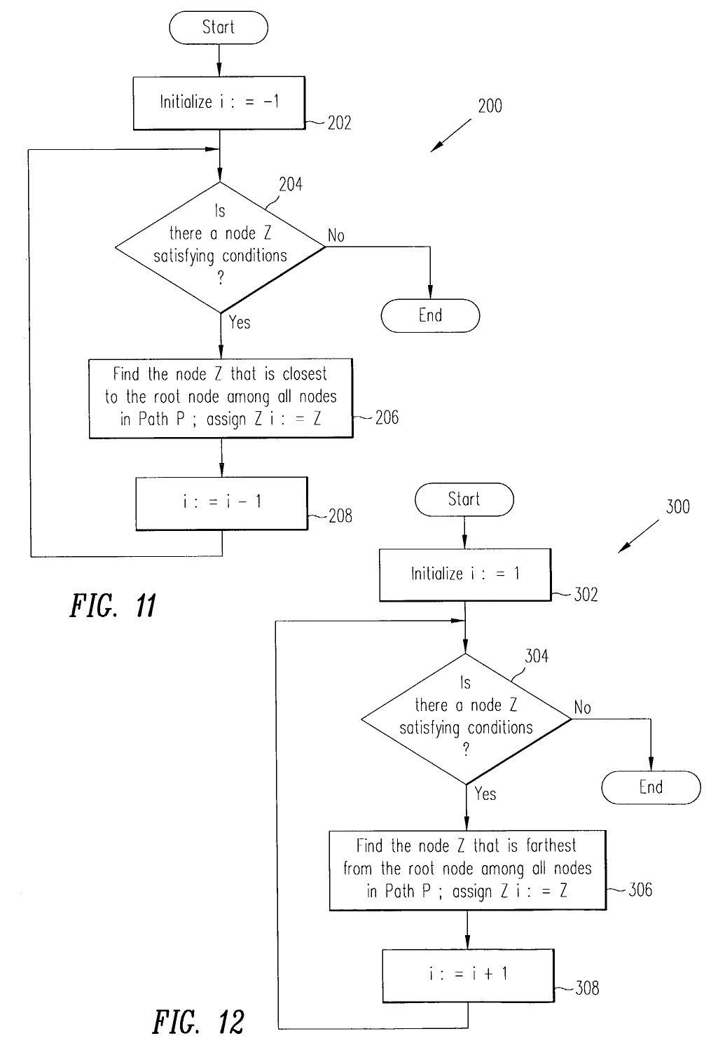

A exemplary flowchart of a method for performing Phase 2 processing is illustrated and described below with reference to FIG. 12.

In Phase 3, the chosen nodes are then ordered in increasing order of distance from the root node, thus obtaining zₗ, . . . , zₖ. That is,

$${z}_{1} := {\overline{z}}_{r}$$

$${z}_{2} := {\overline{z}}_{r - 1}$$

$$…$$

$${z}_{r} := {\overline{z}}_{1}$$

$${z}_{r + 1} := z$$

$${z}_{r + 2} := {\hat{z}}_{1}$$

$${z}_{r + 3} := {\hat{z}}_{2}$$

$$…$$

$${z}_{k} := {\hat{z}}_{s}$$

The corresponding pairs of distances (d₁, h₁), . . . , (dₖ, hₖ) can be calculated at the same time as the zᵢ's are being selected. For any node z₁ the corresponding distance value dᵢ is the distance from node x to node zᵢ, and the corresponding height value hᵢ is the distance from node zᵢ to the root node r.

One of ordinary skill in the art would understand that the ordering of Phase 3 can be carried out concurrently with or as part of the choosing of nodes in Phases 1 and 2, and thus need not be a separate phase.

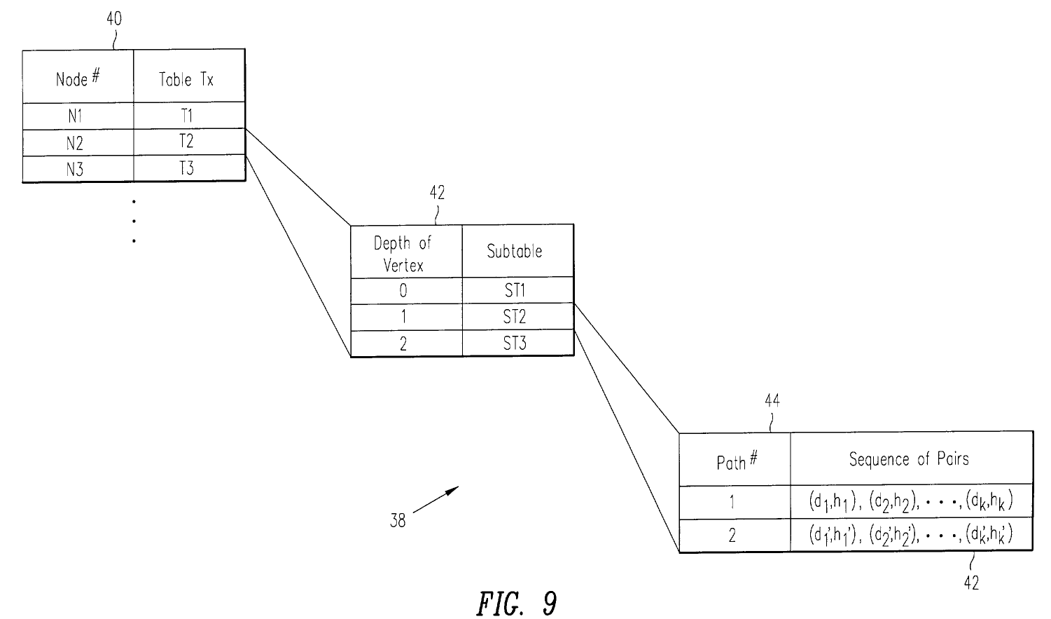

FIG. 9 illustrates a data structure 38 that may be built or constructed for the nodes of a planar graph 10. This structure 38 may be part of a representation for the planar graph 10. As shown, this structure 38 includes a table 40. Table 40 comprises entries for each node of the planar graph 10. Each entry of table 40 may include or specify a respective table 42 (table Tₓ). Each table 42 comprises a number of entries for the depth of all vertices 22 in a recursive-decomposition tree 20 which label the corresponding node. In other words, the table for a node x has an entry for each vertex v of the separator tree such that N(v) contains x; note that the depths of these vertices are all distinct and comprise a contiguous sequence 0, 1, 2, . . . up to some depth. It is sufficient and convenient to represent the table Tₓ for the node x as an array indexed by depth and having the appropriate number of elements. Each entry of a table 42 may include or specify a respective subtable 44. Each subtable 44 may comprise entries for each path that is part of a separator 16 for a particular vertex 22 at a particular depth. Each entry of a subtable 44 may include or specify a sequence of pairs (dᵢ and hᵢ values) which are determined for the various nodes along the respective path.

In an alternative embodiment, in the table Tₓ [v][P], instead of storing pairs of distances (d₁, h₁), . . . , (dₖ, hₖ) where dᵢ is the distance between x and zᵢ, and hᵢ is the distance between the root node r and zᵢ, one can store pairs (d₁, n₁), . . . , (dₖ, nₖ), where n₁, n₂, . . . , nₖ use some way of identifying the nodes z₁, . . . , zₖ of the separator path P. If this approach is taken, the method for distance estimation may use a table (which gives, for each node x in the graph, the distance dₓ of node x from root node r) to obtain the values h₁, . . . , hₖ from n₁, . . . , nₖ. For example, n₁, . . . , nₖ may be the node numbers of the nodes z₁, . . . , zₖ. In this case, finding h₁, . . . , hₖ from n₁, . . . , nₖ consists in simply looking up each n₁ in the table. For another example, in view of the fact that the separator path P is fixed for this table, n₁, . . . , nₖ may be the positions (or indices) of the nodes z₁, . . . , zₖ within the path P. If this approach is taken, the representation may include a table that, for each non-leaf vertex of the separator tree and each of the paths comprising the separator associated with that vertex, an array consisting of the sequence of nodes comprising that path.

Thus, it can be appreciated from FIG. 9 that, in some aspects of one embodiment, the representation includes a first table which has a plurality of first entries, each indexed by a unique identifier for each node. These first entries, in turn, may each comprise a second table which itself has a plurality of second entries, each of which is indexed by the depth value associated with the vertices 22 of a recursive-decomposition tree 20 which correspond to node x. These second entries, in turn, may each comprise a third table which has one or more third entries which are indexed corresponding to the number of shortest paths in the separator 16 corresponding to node x (note that different embodiments of the separator may have one, two, three, or more shortest paths, and two paths are used as merely an exemplary number of paths). These third entries may include the sequence of pairs of distance values (dᵢ, hᵢ) selected according to a method such as Phases 1-3 above (or other appropriate methods). In other embodiments, these third entries may include distance value data which is formatted differently than in strict pairs and, for example, may include pointers for a table for determining distance value data, or may include other appropriate values to directly or indirectly allow determination of distance values.

Method for Representing a Planar Graph

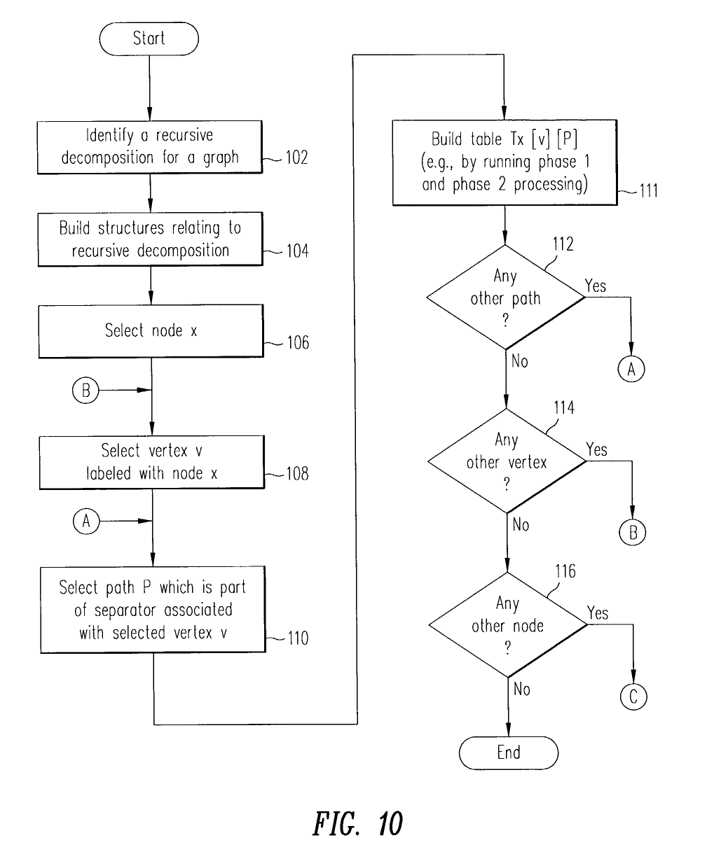

From the above, a method for representing a planar graph 10 G in accordance with one aspect of one embodiment of the invention is provided. FIG. 10 is a flowchart illustrating such a method 100. The planar graph 10 may include a plurality of nodes, which are joined by one or more edges.

Method 100 begins at step 102 where a recursive decomposition for the planar graph 10 is identified. A recursive-decomposition tree 20 for the planar graph 10 includes a plurality of vertices 22 which correspond to respective subgraphs of the graph.

At step 104, one or more structures relating to the recursive decomposition can be built. These structures may include a table which specifies for each node x of the planar graph 10 the lowest vertex 22 v whose corresponding subgraph N(v) contains x, and a table which specifies the depth of each vertex 22 in the recursive-decomposition tree 20. These two tables may be part of a representation for the planar graph 10.

At step 106, a node of the planar graph 10 is selected. At step 108, a vertex 22 labeled with that node is selected. At step 110, a path which is part of a separator 16 associated with the present vertex is selected.

At step 111, a table Tₓ for the present node is built. This may be accomplished by deriving or identifying a sequence of pairs (e.g., dᵢ and hᵢ values) for the selected path, where each dᵢ is the distance from the present node to a reference node along the present path and each hᵢ is the distance from the root node r to a reference node along the present path. In one embodiment, phase 1 and phase 2 processing is performed to choose a set of nodes zᵢ along the path that are closer to or further than the reference node to the root node r.

At step 112, method 100 determines whether there is any other path to be considered for the separator 16 of the present vertex. If there is at least one other path, then method 100 returns to step 110 where the path is selected. Otherwise, method 100 moves to step 114. In this way processing continues until every path of a separator 16 for the present vertex is considered. This builds a subtable (e.g., subtable 44 of FIG. 9) having or specifying sequence pairs (e.g., dᵢ and hᵢ values) for the present vertex.

At step 114, method 100 determines whether there is any other vertex 22 to be considered for the present node. If there is at least one other vertex 22, then method 100 returns to step 108 where the vertex 22 is selected. Otherwise, method 100 moves to step 116. In this way processing continues until every vertex 22 for the present node is considered. This builds a table Tₓ (e.g., table 42 of FIG. 9) having or specifying a subtable for each vertex 22 for the present node.

At step 116, method 100 determines whether there is any other node to be considered for the planar graph 10. If there is at least one other node, then method 100 returns to step 106 where the node is selected. Otherwise, method 100 ends. In this way processing continues until a plurality of nodes of the planar graph 10 are considered; in some embodiments, all nodes may be considered, while in alternate embodiments, some nodes are not considered because such nodes are in a cluster which is not divided by a separator. This builds a table (e.g., table 40 of FIG. 9) having or specifying a table Tₓ for a plurality of nodes for the present planar graph 10.

These tables and subtables built by method 100 can also be part of a representation for the planar graph 10.

Method For Performing Phase 1 Processing

As discussed above, there is a multi-phase process to select a set of nodes zᵢ for which distance values can be determined as part of the representation. As noted above, this process can be a three-phase method as discussed above or, alternatively, can be just as readily described as a two-phase process.

FIG. 11 is a flowchart illustrating a method 200 for performing phase 1 processing in accordance with one aspect of one embodiment of the invention. Method 200 is performed for a node x to choose a set of nodes zᵢ along a particular path P that are closer than a node z₀ to the root node r.

The process starts by letting a reference node z₀ be the node on path P that is closest to the node x (which is the node of graph 10 currently in question for filling out the tables of the representation). In Phase 1, a set of nodes zᵢ is chosen that are closer than a reference node z₀ to the root node r.

Referring to FIG. 11, method 200 starts with a step 202 where the value of index i is initialized to equal −1 (negative one). Method 200 is process which determines a set of nodes z₁ by the following conditions:

While there is a node z in path P that satisfies:

node z is closer to the root node r than node zᵢ₊₁ (condition (1))

d(z)<(1+\overline{ε})⁻¹ (d(z₁₊₁)+h(zᵢ₊₁)−h(z₁)) (condition (2))

let zᵢ be the node z that is farthest from the root node r among all the nodes in path P satisfying conditions (1) and (2).

Referring to FIG. 11, at step 204, method 200 determines if there is a node z satisfying condition (1) and condition (2) discussed above. If not, then method 200 ends. Otherwise, method 200 moves to step 206.

At step 206, the node z that is closest to the root node r among all nodes on path P is found and assigned to be zᵢ. At step 208, i is decremented by 1, and method 200 returns to step 204.

Method For Performing Phase 2 Processing

FIG. 12 is a flowchart illustrating a method 300 for performing phase 2 processing in accordance with one aspect of one embodiment of the invention. Method 300 is performed for a node x to choose a set of nodes zᵢ along a particular path P that are farther than a node z₀ to the root node r.

For Phase 2, reference node zo again is the node on path P that is closest to node x. In Phase 2, a set of nodes zᵢ is chosen that are farther than a reference node z₀ from the root node r.

Referring to FIG. 12, method 300 starts with a step 302 where the value of index i is initialized to equal 1 (one). Method 300 is process which determines a set of nodes zᵢ by the following conditions:

While there is a node z in path P that satisfies:

node z is farther from the root node r than node zᵢ₋₁ (condition (3))

d(z)<(1+\overline{ε})⁻¹(d(zᵢ₋₁)+h(z₁)−h(zᵢ₋₁)) (condition (4))

let zᵢ be the node z that is farthest from the root node r among all the nodes in path P satisfying conditions (3) and (4).

Referring to FIG. 12, at step 304, method 300 determines if there is a node z satisfying condition (3) and condition (4) discussed above. If not, then method 300 ends. Otherwise, method 300 moves to step 306.

At step 306, the node z that is farthest from the root node r among all nodes on path P is found and assigned to be zᵢ. At step 308, i is incremented by 1, and method 300 returns to step 304.

Those of ordinary skill will understand that conditions (1)-(4) discussed above can be described and implemented logically and mathematically in alternative manners. As described above, there are presented two alternative and equal expressions for conditions (1)-(4), and those of ordinary skill will appreciate that there are many different alternative manners to implement these conditions and phases.

It should be noted that all of the above forms of representations for a planar graph can be provided or stored in a variety of different dimensions, factors, formats, byte-conventions, and mathematical notations. Also, the dimensions, factors, data formats, and mathematical notations may vary in various embodiments without departing from the scope of the invention. Moreover, the precise types of data or factors need not be among those illustrated and described with reference to FIGS. 1-12, and those of ordinary skill in the art will understand that there are many types of data or factors which can be used, without departing from the scope of the present invention. FIGS. 1-12 are merely representative examples of some of the variations that can be made, and should not be interpreted as limitations on the invention.

Computing a Distance Estimate

Assuming that a representation for a planar graph 10 (as described above) has been stored, a distance estimate can be computed in O(ε⁻¹) elementary operations. FIG. 13 illustrates two nodes x and y on opposite sides of a separator S(v) for which it is desirable to estimate a distance. The separator S(v) comprises a path P having a number of nodes z.

The distance query between two points is a process which, as discussed above, has utility in a wide range of settings involving network analysis. For purposes of the distance query methods of aspects of the invention, the identification of nodes x and y can be derived from any appropriate source. Thus, for example, nodes x and y can be inputs from user query data, or inputs from a geopositioning device, or address data.

Given two nodes x and y, the system or method according to embodiments of the present invention finds the lowest vertices 22 of the recursive-decomposition tree 20 containing nodes x and y, respectively. Then the computer determines the least common ancestor v of these two vertices 22 (using any known or conventional method), and looks up Tₓ [v] and T_{y}[v] (using the depth of v to index). For each of the two (or three) paths forming the separator S(v) at vertex v, the computer finds an estimate (as described below), and finally takes the smallest of these two (or three) estimates.

In order to estimate the distance between two nodes x and y of the graph G, a computer system first determines the leaves u and v of the recursive-decomposition tree whose node subsets N(u) and N(v) contain x and y respectively. Assume the leaves u and v are different.

If the leaves are the same, the exact distance between u and v can be determined quickly: if the subgraph labeling the leaf has one node, then u must be equal to v, so the distance is zero. If the subgraph has more than one node, as described previously, there is a table giving the distance between every pair of nodes in the subgraph.

Assuming the leaves are u and v are different, the computer system finds the least common ancestor w of the leaves in the decomposition tree 20. Those ordinary skill are familiar with known or conventional methods to find least common ancestors of leaves in a tree. The subset N(w) labeling this tree-vertex w contains both x and y. For each path P of the separator S(w), compute an estimate for the minimum length of any x-to-y path going through P.

For a single path P, the estimate is obtained from the table entries Tₓ [v] [P] and T_{y}[v][P] as follows. Recall that these two table entries provide:

The distance d(x) of x to the closest node of P, and the distance h(x) of this closest node from the root node r of the shortest-path tree.

The distance d(y) of y to the closest node of P, and the distance h(y) of this closest node from the root node r of the shortest-path tree.

A sequence of pairs (d₁(x), h₁(x)), . . . , (dₖ₍ₓ₎(x), hₖ₍ₓ₎(x)) of distances where each dᵢ(x) is the distance from x to a node zᵢ(x) in P, and hᵢ(x) is the distance of zᵢ(x) from the root r, and where the sequence of pairs is in increasing order of its second component hᵢ(x).

A similar sequence of pairs (d₁(y), h₁(y)), . . . , (d_{k(y)}(y), h_{k(y)}(y)) defined relative to y instead of x.

The goal is to find the minimum distance from node x to some node zᵢ(x) to some node zⱼ(v) to node y. There are several ways to do this using the available information; one of ordinary skill in algorithm design, knows of and could find a method that takes O(ε⁻¹) elementary operations. One method takes advantage of the method for selection of the zᵢ(x)'s and the zⱼ(y)'s as described above. This method takes O(ε⁻¹1 ) elementary operations but often many fewer than ε⁻¹

Assume for the following that h(x)≦h(y). (If this is not the case, the roles of x and y should be reversed in the following description.)

If h₁(y)<h₁(x),

let p₁=1

let q₁=max{j:hⱼ(y)<h₁(x)}.

else

let q₁=1

let p₁=max {i:hᵢ(x)<h₁(y)}.

If h_{k(y)}(y)<hₖ₍ₓ₎(x),

let q₂=k(y)

let p₂=min{i:h₁(x)>h_{k(y)}(y)}

else

let p₂=k(x)

let q₂=min {j:hⱼ(y)>hₖ₍ₓ₎(x)}

/* The computation of the estimate involves (dᵢ(x), hᵢ(x)) for i=p₁, . . . , p₂ and (dⱼ(y), hⱼ(y)) for j=q₁, . . . , q₂*/

Initialize i:=p₁ and j:=q₁

Initialize m:=dᵢ(x)+dⱼ(y)+|hᵢ(x)−hⱼ(y)|

While i<p₂ or j<q₂,

If j<q₂ and either i=p₂ or hⱼ₊₁(y)<hᵢ₊₁(x), j:=j+1

Else if i<p₂ and either j=q₂ or h₁₊₁(x)≦hⱼ₊₁(y) i:=i+1

m:=min(m, d₁(x)+dⱼ(y)+hⱼ(y)−h₁(x))

Return the value of (1+\overline{ε})m as the estimate, where \overline{ε}=(1−c)ε is as discussed above. (If the number representation described there is not used, take \overline{ε}=0.)

It is straightforward to implement the above method in such a way that the number of elementary operations is O(k(x)+k(y)). This is guaranteed to be O(ε⁻¹). Binary search can be used in the min and max computations that initialize p₁, p₂, q₁, q₂.

Distance estimation according to aspects of embodiments of the invention can be implemented by several different computational, data formatting, arithmetic, and combinatorial methods. Different factors can be added to the process before or during the process. Those of ordinary skill will understand that addition of other factors may be accomplished in any of a variety of known methods and the invention is not limited by the specific method utilized.

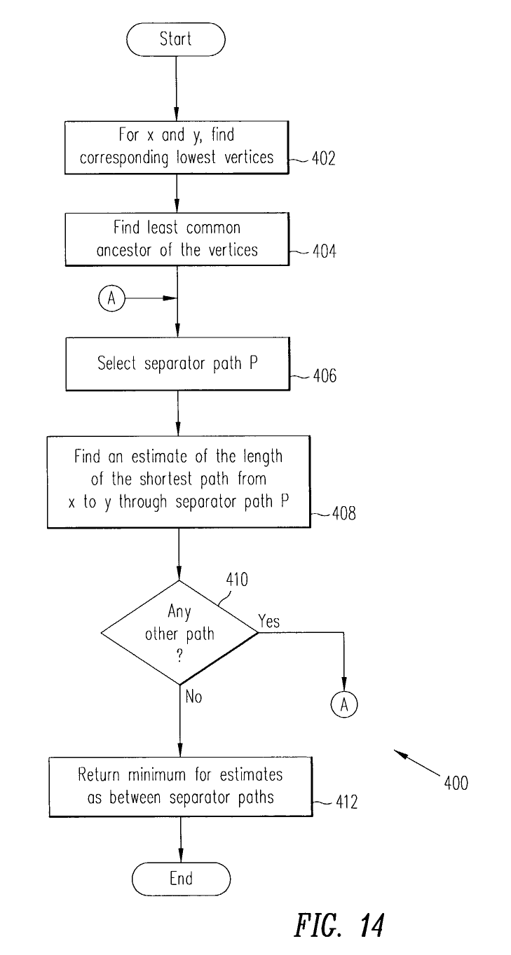

From the above, a method for estimating distance in accordance with one aspect of one embodiment of the invention is provided. FIG. 14 is a flowchart illustrating such a method 400. Method 400 can be used to estimate a minimum or shortest distance between two nodes x and y in a planar graph 10. Method 400 may use the representation of the planar graph 10 described above (which may include, for example, a structure or table specifying a lowest vertex 22 of a recursive-decomposition tree 20 for each node of the planar graph 10, a structure or table specifying the depth of each vertex 22 in the recursive-decomposition tree 20, and a structure for a table indexed by nodes and having distance values for shortest paths.

Method 400 begins step 402 where the lowest corresponding vertices 22 for nodes x and y are found or identified. With the representation of a planar graph 10 described herein, this can be accomplished with a simple lookup in a table. At step 404, the least common ancestor of the vertices 22 for nodes x and y is found, using features discussed above which allow for fast computation of least common ancestor.

At step 406, one path for a separator 16 which separates nodes x andy is selected. At step 408, an estimate is found for the length of the shortest path from node x to node y through the selected path.

At step 410, method 400 determines whether there is any other path of the separator 16 between nodes x and y. If there is, method 400 returns to step 406. Steps 406 through 410 are repeated until an estimate is derived of the length of the shortest path for each path P of the separator 16 between nodes x andy. When there are no other paths P of the separator 16 to consider, method 400 moves to step 412 where it returns the minimum of the various estimates for the paths P of the separator 16. Afterwards, method 400 ends.

Alternate Aspects of Adaptation of Thorup's Method to Undirected Graphs

In another aspect, a simplified version of Thorup's method is provided that applies to undirected graphs. This omits ideas of Thorup's method that are needed only for directed graphs.

The basic idea of Thorup's method is as follows. Let Dₘᵢₙ and Dₘₐₓ be, respectively, the minimum distance and the maximum distance between nodes of the graph. Define dᵢ=2ⁱDₘᵢₙ for i=1, 2, . . . , m where m=┌ log₂(Dₘₐₓ/Dₘᵢₙ)┐. For each integer i between 1 and m, the previously known method constructs a representation that facilitates accurate estimation of the distance between two nodes if that distance is between dᵢ/2 and dᵢ. (If the distance lies outside that range, the estimate is at least the true distance but may be much more than the true distance.) In order to find the best estimate, the computer uses binary search to find the correct value of i; binary search requires the computation of at most ┌logm┐ distance estimates.

The representation for a single i is now described. The representation of the graph G consists of four parts:

A division of the graph G into a collection of graphs G_{i,1}, G_{i,2}, . . . , G_{i,bi} where each node of the original graph G lies in at most three graphs Gᵢⱼ, and for any pair of nodes at distance at most 2dᵢ, the nodes and the path between them lie in a common graph Gᵢⱼ.

A recursive decomposition of each graph Gᵢⱼ using separators each of which consists of a small number of paths (two or three, depending on the exact technique used), each of length O(dᵢ). The subgraphs labeling the leaves of the decomposition each consists of a single node.

A division of each of the paths forming each separator into O(ε⁻¹) node-disjoint segments, each of length at most (ε/2)dᵢ. In each segment, select one node, the segment node for that segment.

Node-Table: For each node x of the graph, a table. The table is indexed by tree-vertices v of the decomposition for which N(v) contains the graph node x. Each entry of the table is a subtable indexed by the segments comprising the separator S(v). Each entry of the subtable is the distance from x to the segment node of the segment.

The depth of the recursive decomposition is O(logn) where n is the number of nodes in G. Hence each table in the fourth part has O(logn) entries. Each entry is itself a subtable of size O(ε⁻¹). For each value of i, each node is in at most three graphs Gᵢⱼ. Hence the total number of words of storage is O(nε⁻¹ logn) for a single value of i (and therefore O(nε⁻logn log D) over all values of i).

A graph may be divided into subgraphs as follows. First compute a shortest-path tree Tₛₕₒᵣₜ in G rooted at an arbitrary node. Let D₁ denote the distance of the farthest node from the root. Let bᵢⱼ=jd₁/2 for j=0, 1, 2, . . . , bᵢ, and let c₁ⱼ=min(bᵢⱼ+3dᵢ/2, D₁), where bᵢ=└2Di/di┘. The graph G_{1,j} is the subgraph of G induced by the set of nodes whose distances from the root lie in the range [bᵢⱼ, c₁ⱼ].

A recursive decomposition may be found using path separators. The method of path separators is applied to a subgraph G_{1,j} as follows. Starting with the original graph G and its shortest-path tree T, contract every edge of the shortest-path tree Tₛₕₒᵣₜ having at least one endpoint at distance less than b_{i,j}, preserving a planar embedding. Delete every edge having at least one endpoint at distance greater than cᵢⱼ. The resulting embedded planar graph is designated G_{i,j}Apply the lemma to the resulting graph, obtaining a separator which includes two paths down the shortest-path tree (or three, depending on the exact separator method), each of length at most cᵢⱼ−b_{i,j}, which is 3dᵢ/2.

The root r of the recursive decomposition is labeled with the subgraph G_{i,j} and with the separator found. Let G′_{i,j} be the subset of the graph consisting of the strict exterior of the separator cycle, and let G″_{1,j} be the subset of the graph consisting of the strict interior of the separator cycle.

Further aspects, such as memory formats, data byte formatting, hardware considerations, and techniques for commercial optimization, are known to those of ordinary skill.

System Impolementation

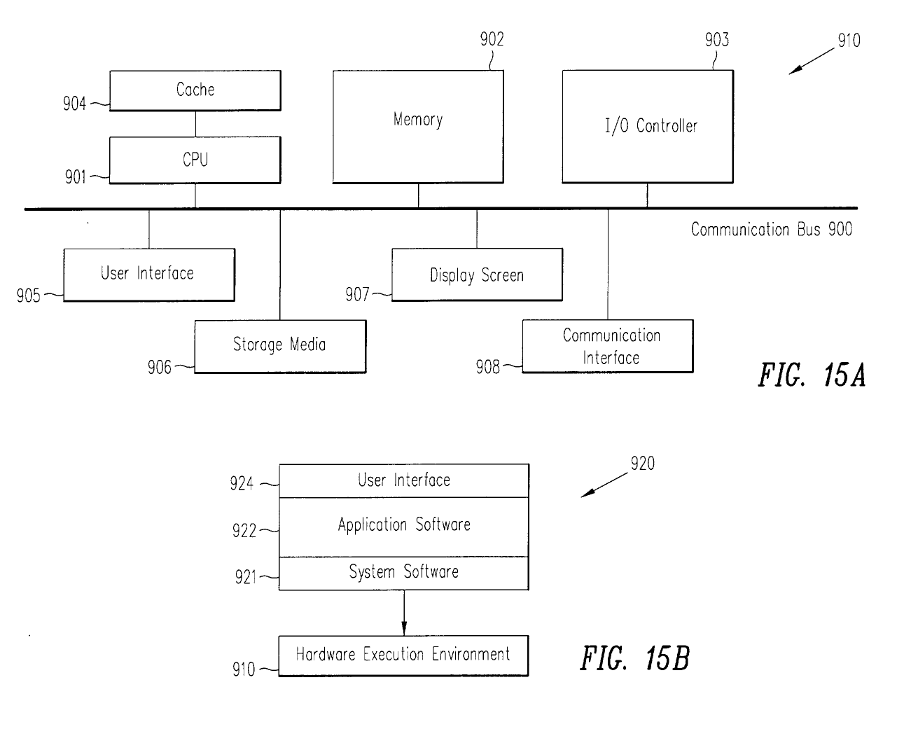

FIGS. 15A and 15 B are block diagrams illustrating the hardware and software environments in which a system for performing the methods and techniques described herein may operate, in accordance with one or more embodiments. In accordance with one or more embodiments, a system for performing the techniques and methods described herein can be implemented in one or both hardware and software. The hardware includes the machinery and equipment that provide an execution environment for the software. The software provides the execution instructions for the hardware.

In one embodiment, the software can be divided into two major classes including system software and application software. System software includes control programs, such as the operating system (OS) and information management systems that instruct the hardware how to function and process information. Application software is a program that performs a specific task. As provided herein, in embodiments of the invention, system and application software are implemented and executed on one or more hardware environments.

Referring to FIG. 15A, an embodiment of the system can include software in the form of computer readable code executed on a general purpose computing system 910 (or computing platform). As depicted, computing system 910 includes a central processor unit (CPU) 901, a main memory 902, an input/output controller 903, optional cache memory 904, user interface devices 905 (e.g., keyboard, pointing device), storage media 906 (e.g., hard drive), a display screen 907, and a communication interface 908 (e.g., an integrated services digital network (ISDN) card). A communication bus 900 is utilized to connect the above system components. Computing system 910 may be capable of communicating with other systems through communication interface 908.

In one or more embodiments, computing system 910 may not include all the above components, or may include additional components for additional functionality or utility. For example, computing system 910 can be a laptop computer or other portable computing device that can send messages and receive data through communication interface 908. Computing system 910 may be partially or fully embodied in an embedded system such as a set-top box, a personal data assistant (PDA), a wireless communication unit (e.g., cellular phone), web televisions, or other similar hardware platforms that have information processing and/or data storage capabilities.

Communication interface 908 can send and receive electrical, electromagnetic, or optical signals that carry digital data streams representing various types of information including logic code. The logic code can be executed by central processor unit 901 or is stored in storage media 906 or other non-volatile storage for later execution. Logic code may be transmitted via a carrier wave or may be embodied in any other form of computer program product. In one or more embodiments, processor 901 is a microprocessor manufactured by Motorola,® Intel® MIPS, or Sun Microsystems® Corporations. The named processors are for the purpose of example only. Any other suitable microprocessor, microcontroller, or microcomputer may be utilized.

FIG. 15B illustrates exemplary computer software 920 suited for managing and directing the operation of the hardware environment described above. Computer software 920 is, typically, stored in storage media 906 and is loaded into memory 902 prior to execution. Computer software 920 may comprise system software 921 and application software 222. System software 921 includes control software such as an operating system that controls the low-level operations of computing system 910. In one or more embodiments of the invention, the operating system is Microsoft Windows 2000, ® Microsoft Windows NT,® Macintosh OS,® UNIX,® LINUX,® or any other suitable operating system may be utilized.

Application software 922 can include one or more computer programs that are executed on top of system software 921 after being loaded from storage media 906 into memory 902. In a client-server architecture, application software 922 may include client and/or server software. Further, computer software 920 includes a user interface software 924 for receiving user commands and delivering content to a user.

In one embodiment, a system of the present invention may be in communication with one or more other suitable communication networks, such as a wireless telecommunications network (not expressly shown). The wireless telecommunications network may include one or more transceiver stations (e.g., for microwave), switches, wire lines, fiber-optic cable, land-based transmission towers, space-based satellite transponders, etc., implementing or supporting, for example, numerous cell sites. The wireless telecommunications network may further be supported by one or more telecommunications lines, such as an analog telephone line, a digital T1 line, a digital T3 line, or an OC3 telephony feed. In one embodiment, the telecommunications network may include any other suitable communication system, such as a specialized mobile radio (SMR) system. In general, the wireless telecommunications network may include or be supported by a public switched telephone network (PSTN) and/or a private system (e.g., cellular system). As such, the wireless telecommunications network may support a variety of communications, including, but not limited to, local telephony, toll (i.e., long distance), and wireless (e.g., analog cellular system, digital cellular system, Personal Communication System (PCS), Cellular Digital Packet Data (CDPD), ARDIS, RAM Mobile Data, paging, and Enhanced Specialized Mobile Radio (ESMR)). The wireless telecommunications network may utilize various calling protocols (e.g., Inband, Integrated Services Digital Network (ISDN) and Signaling System No. 7 (SS7) call protocols) and other suitable protocols (e.g., Enhanced Throughput Cellular (ETC), Enhanced Cellular Control (EC2), MNP10, MNP10-EC, Throughput Accelerator (TXCEL), Mobile Data Link Protocol, etc.). Transmissions over the wireless telecommunications network may be analog or digital. Transmission may also include one or more infrared links (e.g., IRDA).

Computing platform 910 may comprise a server computer adapted to support centralized computing functions to a large number of users or clients. For example, computing system 910 can be configured to implement embodiments of the invention and computing system 910 may use communication interface 908 to send and receive user data, instructions, and requests to perform methods of estimating distance in accordance with embodiments of the invention. Computing system 910 can communicate through communication interface 908 to users the results of distance estimation processes in accordance with embodiments of the invention. For example, computing system 910 can be adapted to communicate with users over the Internet, an Intranet, a wide area network, a cellular phone network, a pager network, a telecommunications network, or a wireless communication network. There may be some advantages in a client-server arrangement which implements embodiments of this invention, such as ease of data upgrade at a centralized or minimal number of locations, ease of code maintenance, removing the need for users to use large amounts of memory storing data such as graph 10, computing power and speed considerations, and ease of upgrades.

Those of ordinary skill will appreciate that, in some applications, users may submit queries for distance estimates to computing system 910 over any appropriate communications interface or network, and computing system 910 (implementing one or more embodiments of the invention) may derive a distance estimate, and subsequently communicate the distance estimate to the user over a communications interface or network. Those of ordinary skill will appreciate that, in some embodiments, aspects of the invention may be useful in supporting a wide range of applications involving the Internet, cellular phones, push applications, pull applications, wireless web, mobile computing, Bluetooth, intelligent vehicle systems, advanced transportation information systems, military command and control, governmental command and control, and similar systems.

Those of ordinary skill will understand that human users need not be necessary to submit queries for distance estimates, and other machines, computers, software, or devices may trigger requests for distance estimates.

Those of ordinary skill will appreciate that computing system 910 can be used a wide range of environments and applications. For example, in some embodiments, computing system 910 may be adapted for use in either a stand-alone or networked kiosk whereby users can input requests for distance estimates using an interface provided with the kiosk. In another embodiment, computing system 910 can be adapted for use in a laptop computer. In another embodiment, computing system 910 can be adapted for use in a motor vehicle which is moveable on the streets, roads, highways, alleys, and connectors which may be represented in a network graph 10. In another embodiment, computing system 910 can be adapted for use in any transportation device (such as a boat, airplane, bus, train, etc.) which traverses spaces (such as canals, linked waterways, railways, airplane routes, runways, etc.) which can be represented as a network graph 10.

While various embodiments of the invention have been shown and described, it will be apparent to those of ordinary skill in the art that numerous alterations may be made without departing from the scope of the invention or inventive concepts presented herein. Persons of ordinary skill will appreciate that changes can be made to dimensions, sizing, relative dimensions, inputs, factors, combinations of factors, spatial and angular relationships of and between components, and manufacturing and storage processes and other commercial or industrial techniques, all without departing from the scope of the invention. Also, those of ordinary skill will understand that the various steps, acts, methods, and sub-steps described with respect to alternate embodiments may be rearranged, substituted, or combined with each other and that various process steps and sub-processes described above with respect to alternate embodiments may be rearranged, substituted, or combined with each other, all without departing from the scope of the invention. Thus, the invention is not to be limited except in accordance with the following claims and their equivalents.

What is claimed is:

1. A process for constructing a representation of a network, comprising:
providing an input graph, wherein the input graph comprises nodes and edges;
deriving at least one separator comprising one or more shortest paths comprising a plurality of nodes, wherein said nodes in said shortest paths comprise portal nodes;
deriving a recursive decomposition tree of said input graph, wherein said recursive decomposition tree comprises a plurality of vertices, each vertex having a depth value and each vertex corresponding to one or more nodes;
compiling a first table of data for nodes of said graph wherein said first table has a plurality of first entries each indexed by a node;
deriving, for each node in said first table, a second table from said recursive decomposition tree wherein said second table has a plurality of second entries each indexed according to said depth value of said vertices;
deriving, for each said depth value in said second table, a third table having a plurality of third entries indexed according to said shortest paths of said separator; and
deriving, for each said indexed third entries, corresponding distance values.

2. A process in accordance with claim 1, wherein:
said nodes of said input graph comprise at least one root node; and
said distance values comprise a sequence of said pairs of distance values, wherein a first value in each pair represents portal distance from a node to a portal node and a second value in each pair represents distance from said portal node to a root node.

3. A process according to claim 1, wherein:
said nodes of said input graph comprise at least one root node;
said distance values comprise a sequence of said pairs of values, wherein a first value in each pair represents portal distance from a node to a portal node and a second value in each pair represents an identifier for said portal node; and
further comprising a fourth table having fourth entries indexed by portal node identifiers, wherein said fourth entries comprise data representing distance from each said portal node to a root node.

4. A process according to claim 2, wherein the act of deriving corresponding sequences of pairs of distance values comprises:
deriving a first set of nodes that are closer to the root node than a reference portal node; and
deriving a second set of nodes that are farther from the root node than said reference portal node.

5. A process according to claim 4, further comprising:
determining a distance value comprising a distance between each node of said graph and each node in said set first and second sets of nodes;
determining a height value comprising a distance between each node in said first and second sets of nodes and said root node;
pairing each distance value with each corresponding height value for each node in said first and second sets of nodes;
ordering said first and second sets of nodes in increasing order based on distance of each said node from said root node.

6. A process according to claim 4, wherein:
for each node of the graph, said reference portal node comprises a portal node closest to each said node of the graph;
wherein said process of deriving a first set of nodes comprises:
initializing a first index i to a value of negative one (−1);
while there is a node z in said shortest path which satisfies a first condition wherein said node z is closer to said root node than node zᵢ₊₁ and satisfies a second condition wherein the distance from each said node of said graph to said node z is less than a first threshold factor, assigning node zᵢ the value of node z;
decrementing the value of said first index i by one (−1); and
wherein said process of deriving a second set of nodes comprises:
initializing a second index i to a value of one (1);
while there is a node z in said shortest path which satisfies a third condition wherein said node z is farther from said root node than node zᵢ₋₁ and satisfies a fourth condition wherein the distance from each said node of said graph to said node z is less than a second threshold factor, assigning node z₁ the value of node z;
incrementing the value of said second index i by one (1).

7. A process according to claim 6, wherein:
said first threshold value comprises the value of
(1+bar-ε)⁻¹(d(zᵢ₊₁)+h(z₁₊₁)−h(zᵢ))
wherein bar-ε comprises a factor having value between zero and one, and wherein d(zᵢ₊₁) comprises a distance from each said node in said graph to node zᵢ₊₁, and wherein h(zᵢ₊₁) comprises a distance from said root node to node zᵢ₊₁ and h(zᵢ) comprises a distance from the root node to node zᵢ; and
said second threshold value comprises the value of
(1+bar-ε)⁻¹(d(zᵢ₋₁)+h(z₁)−h(zᵢ₋₁))
wherein bar-ε comprises a factor having value between zero and one, and wherein d(zᵢ₋₁) comprises a distance from each said node in said graph to node zᵢ₋₁, and wherein h(zᵢ₋₁) comprises a distance from said root node to node zᵢ₋₁ and h(zᵢ) comprises a distance from the root node to node zᵢ.

8. A representation of a network, comprising:
an input graph comprising nodes and edges;
one or more separators comprising one or more shortest paths, each comprising a plurality of nodes, wherein said nodes in said shortest paths comprise portal nodes;
a recursive decomposition tree of said input graph, wherein said tree comprises a plurality of vertices, each vertex having a depth value and each vertex corresponding to one or more nodes;
a first table of data for nodes of said graph wherein said first table has a plurality of first entries each indexed by node;
for each said first entry in said first table, a second table having a plurality of second entries each indexed according to said depth value of said vertices;
for each said second entry in said second table, a third table having a plurality of third entries each indexed according to said shortest paths of said at least one separator;
for each said third entry in said third table, corresponding distance values;
wherein for any node w on a shortest path, there is a node z such that the distance from a corresponding vertex v to node z plus the distance from node z to node w is at most (1+(1−c/2)ε₀) times the distance from said vertex v to node w, wherein c is a factor ranging in value from zero to one and ε₀ is a factor ranging in value between zero and one.

9. A representation accordance to claim 8, wherein:
said nodes of said input graph comprise at least one root node; and
said distance values comprise a sequence of said pairs of distance values, wherein a first value in each pair represents portal distance from a node to a portal node and a second value in each pair represents distance from said portal node to a root node.

10. A representation according to claim 8, wherein:
said nodes of said input graph comprise at least one root node;
said distance values comprise a sequence of said pairs of values, wherein a first value in each pair represents portal distance from a node to a portal node and a second value in each pair represents an identifier for said portal node; and
further comprising a fourth table having fourth entries indexed by portal node identifiers, wherein said fourth entries comprise data representing distance from each said portal node to a root node.

11. A representation in accordance with claim 8, wherein said input graph represents an undirected embedded planar network.

12. A representation in accordance with claim 8, wherein said input graph represents an undirected embedded nearly-planar network.

13. A representation in accordance with claim 8, wherein said input graph represents a roadway network.

14. A representation in accordance with claim 8, whereby a processed representation of an undirected network is adapted for use in route planning.

15. A representation in accordance with claim 8, whereby a processed representation of an undirected network is adapted for use in navigation.

16. A representation in accordance with claim 8, whereby a processed representation of an undirected network is adapted for use in trigger alert applications.

17. A representation according to claim 8, whereby a processed representation of an undirected embedded network is adapted for use in polling server applications.

18. A representation according to claim 8, whereby a processed representation of an undirected embedded graph is adapted for use in point-of-interest query applications.

19. A representation according to claim 8, wherein:
each said node is associated with a vertex in a fourth table indexed by a unique node identifier for each said node and wherein each said vertex has a unique vertex identifier; and
each vertex's depth value is stored in a fifth table indexed by said unique vertex identifiers, and wherein said fifth table further comprises data identifying the parent vertex for each said vertex, wherein the parent vertex for each said vertex is one depth value closer to said root node.

20. A representation according to claim 19, wherein said unique vertex identifiers comprise binary values assigned in dependence on the path from said root node to each vertex.

21. A representation according to claim 19, wherein said unique vertex identifiers comprise unique, sequentially-assigned numerical identifiers for each vertex.

22. A process for estimating distance, comprising:
providing an input graph comprising nodes and edges;
deriving at least one separator comprising at least one shortest path;
providing a representation of said graph comprising:
a recursive-decomposition tree of said graph, said recursive-decomposition tree having vertices each of which has a depth value and wherein each node of said graph has at least one corresponding vertex;
a first table comprising first entries indexed by each node in said graph, wherein each said first entry comprises a second table;
said second table comprising second entries indexed by the depth values of vertices corresponding to each node, wherein each said second entry comprises a third table;
said third table comprising third entries indexed by said at least one shortest path,
wherein each said third entry comprises distance data;
obtaining a first endpoint, comprising one of said nodes of said graph, and a second endpoint, comprising a second of said nodes of said graph;
determining the least common ancestor vertex for the first endpoint and the second endpoint, said least common ancestor vertex having one of said depth values;
looking up, in said second table, a second entry indexed according to said least common ancestor's depth value;
for each shortest path index in said third table, deriving distance values indexed according to said at least one shortest path;
for each shortest path index in said third table, determining a candidate estimated minimum distance between said first endpoint and said second endpoint using said distance values; and
determining a minimum estimated distance from said first endpoint to said second endpoint from among the set of all said candidate estimated minimum distances determined using said distance values.

23. A process in accordance with claim 22, wherein said separator comprises no more than two shortest paths.

24. A process in accordance with claim 22, wherein a plurality of said first endpoints and a plurality of said second endpoints are in a cluster corresponding to a vertex.

25. A process in accordance with claim 24, wherein said first endpoints and said second endpoints in said cluster are not divided by a separator.

26. A process in accordance with claim 25, wherein distance between one of said first endpoints and one of said second endpoints is derived from a look up table.

27. A system for estimating distances, comprising:
a computing platform comprising a processor and a memory, wherein a processed representation of an undirected network is stored in said memory;
said processed representation comprising nodes and edges;
said processed representation further comprising a recursive-decomposition tree of said network, said tree comprising vertices each having a depth value;
said processed representation further comprising tables comprising distance value data;
said computer adapted to identify a first node and a second node, each said node having corresponding vertices in said tree, and said first node and said second node having a least common ancestor vertex;
said computer configured to determine a minimum estimated distance between said first node and said second node, by deriving from said tables corresponding distance value data indexed according to the depth value of said least common ancestor vertex.

28. A system in accordance with claim 27, wherein said computing platform comprises a server adapted for supporting wireless applications.

29. A system in accordance with claim 27, wherein said computing platform is adapted for use in a kiosk.

30. A system in accordance with claim 27, wherein said computing platform comprises a wireless device.

31. A system in accordance with claim 30, wherein said wireless device comprises a device chosen from the set of cellular phones, personal digital assistants, laptop computers, wireless e-mail devices, and pagers.

32. A system in accordance with claim 27, wherein said computer is located in a vehicle movable over streets represented by said network.

33. A method for estimating distances using a processed network representation, comprising:
step for providing an input graph comprising nodes and edges;
step for storing a processed representation of said graph;
step for determining a first location and a second location, each said location having data associated therewith;
step for determining from said processed representation and said locations' associated data a minimum estimated distance between said first location and said second location.
